(19) United States
(12) Patent Application Publication
(10) Pub. No.: US 2007/0229442 A1
(43) Pub. Date: Oct. 4, 2007

(54) LCD device and driving circuit thereof

(75) Inventor: Chien-Yu Yi, Hsin-Chu (TW)

Correspondence Address: BACON & THOMAS, PLLC, 625 SLATERS LANE, FOURTH FLOOR, ALEXANDRIA, VA, 22314, US

(73) Assignee: AU Optronics Corp., Hsin-Chu (TW)

(21) Appl. No.: 11/723,035

(22) Filed: Mar. 16, 2007

(30) Foreign Application Priority Data
Mar. 31, 2006 (TW) 095111479

(51) Int. Cl. G09G 3/36

(52) U.S. Cl. 345/100

(57) ABSTRACT

A liquid crystal display device and driving circuit thereof are provided. The liquid crystal display device includes a storage unit, an external gamma reference voltage generator and a source driver IC. The storage unit stores a plurality of digital gamma data each relating to at least one predetermined color. The source driver IC further comprises an internal gamma reference voltage generator and a digital to analog converter module. The internal gamma reference voltage generator generates a plurality of internal gamma reference voltage to the digital to analog converter module according to the digital gamma data supplied by the storage unit. The digital to analog converter module also receives a plurality of external gamma reference voltages supplied by the external gamma reference voltage generator.

### BACKGROUND OF THE INVENTION

1. Field of the Invention

The present invention relates to flat panel displays, and more particularly, to liquid crystal displays (LCDs) and driving circuits thereof.

2. Description of Related Art

FIG. 1 is a schematic diagram illustrating a source driver integrated circuit (IC) 1 for use in a conventional LCD display (not shown). The source driver IC 1 comprises a shift register 10, a data register 11, a data latch (also known as line latch) 12, a level shifter 13, a digital analog converter (DAC) 14, and an output buffer 15. The source driver IC 1 sequentially latches the RGB (Red, Green and Blue) data input thereto, converts the RGB data, and then outputs data voltages corresponding to the RGB data to the data lines on the display panel. According to the gamma reference voltage provided by a gamma reference voltage generator 2, the DAC 14 converts the RGB data provided and level-shifted by the data latch 12 and the level shifter 13, respectively.

A plurality of transmission lines 21 exist between the gamma voltage generator 2 and the DAC 14. Generally, the number of the transmission lines 21 used depends on the resolution of the source driver IC 1. For instance, when the source driver IC 1 has a 6-bit resolution, ten transmission lines 21 are required; when source driver IC 1 has an 8-bit resolution, sixteen to twenty transmission lines 21 are required.

In conventional LCDs, the differences in optical properties of the RGB pixels are not taken into account, and only a single gamma reference voltage related to the pixels is provided to the DAC 14. However, in practical application, the optical properties of the RGB pixels are different, and the negligence of this consideration only results in the unbalance of gray levels of the colors displayed on the panel and visible color discrepancies on screen.

To solve the aforementioned problems, three different sets of the gamma reference voltages characteristically related to the RGB pixels can be provided to the DAC 14, accompanied by an increase in the number of the transmission lines 21. For instance, when the source driver IC has a 6-bit resolution, the RGB pixels applied with a same gamma reference voltage would only require ten transmission lines; but instead if the RGB pixels are applied with three different sets of gamma reference voltages for the three respective RGB colors, then thirty transmission lines would be required, resulting in a steep increase in the printed circuit board (PCB) wiring area and manufacturing costs.

### SUMMARY OF THE INVENTION

It is therefore an object of the present invention to provide an LCD device and the driving circuit thereof for reducing a wiring area of a PCB.

It is therefore another object of the present invention to provide an LCD device and the driving circuit thereof for reducing manufacturing costs.

According to one aspect of the invention, a driving circuit of an LCD device is provided. The driving circuit comprises a storage unit and a source driver integrated circuit (IC). The storage unit is for storing a plurality of digital gamma data, and the storage unit can be a non-volatile memory, such as an Electrically Erasable Programmable Read-Only Memory (EEPROM), an Erasable Programmable Read-Only Memory (EPROM), or a flash memory.

The source driver IC is electrically connected to the storage unit through a serial transmission line, for example, through which the digital gamma data are transmitted from the storage unit to the source driver IC. The source driver IC further comprises a first gamma voltage generator and a DAC module. The first gamma voltage generator generates a plurality of sets of first gamma reference voltages according to the digital gamma data. The first gamma voltage generator outputs the first gamma reference voltages to the DAC module. The DAC module receives the first gamma reference voltages supplied by the first gamma voltage generator, and receives a plurality of second gamma reference voltages. The first gamma reference voltages are characteristically related to the gamma curve of a plurality of first predetermined colors. The second gamma reference voltages are characteristically related to the gamma curve of a second predetermined color. For instance, the first predetermined colors can be RGBW (Red, Green, Blue, and White), or RGBY (Red, Green, Blue and Yellow), or RGBC (Red, Green, Blue, and Cyan). The digital analog converter module converts video data according to the first gamma reference voltages or the second gamma reference voltages.

According to another aspect of the present invention, an LCD device is provided. The LCD device comprises a display panel, a storage unit, and at least one source driver IC. The storage unit is for storing a plurality of digital gamma data. The source driver IC is electrically connected to the display panel, and electrically connected to the storage unit through serial transmission lines, for example, through which the digital gamma data are transmitted from the storage unit to the at least one source drive IC. The source driver IC further comprises a first gamma voltage generator and a DAC module. The first gamma voltage generator generates a plurality of sets of first gamma reference voltages according to the digital gamma data, and outputting the generated first gamma reference voltages to the DAC module. The DAC module receives the first gamma reference voltages from the first gamma voltage generator and receives a plurality of second gamma reference voltages. The first gamma reference voltages are characteristically related to the gamma curve of a plurality of the first predetermined colors. The second gamma reference voltages are characteristically related to the gamma curve of a plurality of the second predetermined colors. The DAC module therefore converts the video data according to the first gamma reference voltages or the second gamma reference voltages.

The first gamma voltage generator comprises a deserializer, a positive gamma reference voltage generator, and a negative gamma reference voltage generator. The deserializer is electrically connected to the positive gamma reference voltage generator and the negative gamma reference voltage generator.

The deserializer receives the serial digital gamma data supplied by the storage unit and divides the serial digital gamma data into a first digital data and a second digital data for outputting to the positive gamma reference voltage generator and the negative gamma reference voltage generator, respectively.

The positive reference voltage generator generates a plurality of sets of positive gamma reference voltages according to the first digital data for outputting to the DAC module. The negative reference voltage generator generates a plurality of sets of negative gamma reference voltages according to the second digital data for outputting to the DAC module.

The positive gamma reference voltage generator comprises a first DAC, a first sample-and-hold circuit, and a plurality of first unity-gain buffers. The first DAC is electrically connected to the deserializer and the first sample-and-hold circuit. The first sample-and-hold circuit is electrically connected to the first unity-gain buffers.

The first DAC receives the first digital data and converts the same into one of the first gamma reference voltages to be transmitted to one of the first unity-gain buffers and output to the DAC module.

The negative gamma reference voltage generator=comprises a second DAC, a second sample-and-hold circuit, and a plurality of second unity-gain buffers. The second DAC is electrically connected to the deserializer and the second sample-and-hold circuit. The second sample-and-hold circuit is electrically connected to the second unity-gain buffers.

The digital gamma data reference table is stored in the storage unit in the form of reference tables, and the source driver IC determines the reference table for use therefrom according to an environmental parameter (e.g., temperature).

Other objects, advantages, and novel features of the present invention will become more apparent from the following detailed description when taken in conjunction with the accompanying drawings.

### BRIEF DESCRIPTION OF THE DRAWINGS

FIG. 1 is a schematic diagram illustrating the source driver IC of a conventional LCD.

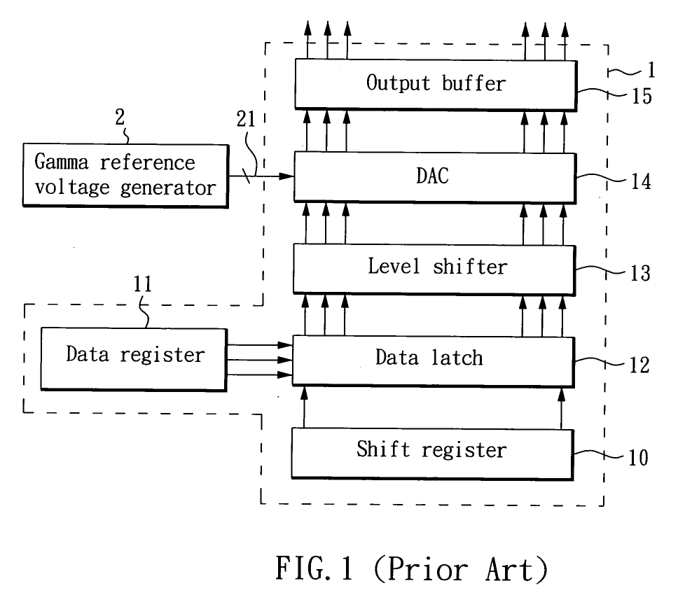

FIG. 2 is a functional block diagram illustrating a preferred embodiment of the invention.

FIG. 3 is a functional block diagram illustrating a gamma voltage generator according to a preferred embodiment of the invention.

FIG. 4 is a schematic diagram illustrating a preferred embodiment of the invention.

FIG. 5 is a plot illustrating the gamma curve of a source driver IC according to a preferred embodiment of the invention.

### DETAILED DESCRIPTION OF THE PREFERRED EMBODIMENT

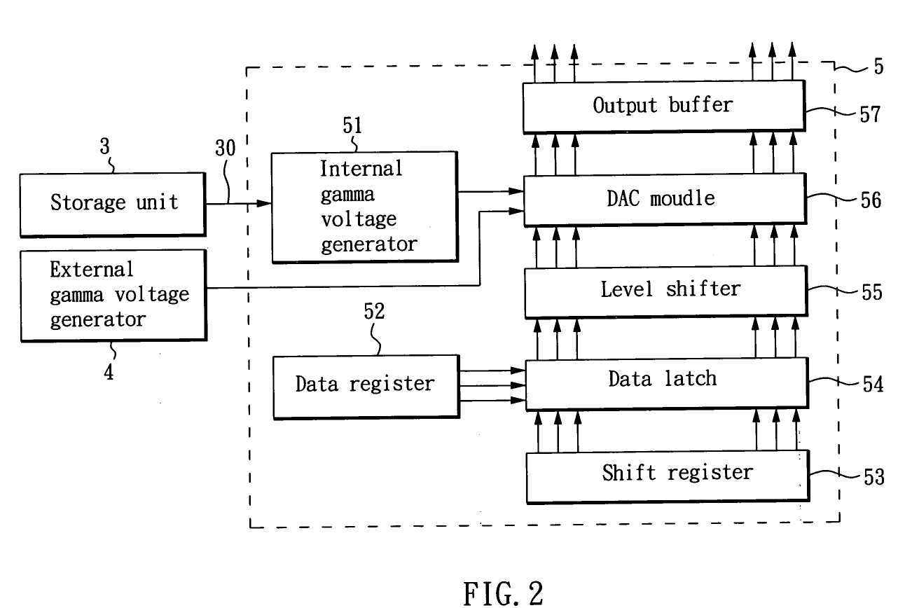

FIG. 2 is a functional block diagram illustrating a preferred embodiment of a driving circuit, according to the present invention. The driving circuit 20 comprises a storage unit 3, an external (second) gamma voltage generator 4, and a source driver IC 5. The source driver IC 5 comprises an internal (first) gamma voltage generator 51, a data register 52, a shift register 53, a data latch 54, a level shifter 55, a DAC module 56, and an output buffer 57.

The storage unit 3 is electrically connected to the source driver IC 5. For instance, the storage unit 3 is electrically connected to the internal gamma voltage generator 51 of the source driver IC 5 through a serial transmission line 30, for example. The external gamma voltage generator 4 and the internal gamma voltage generator 51 are both electrically connected to the DAC module 56. The DAC module 56 is electrically connected to the output buffer 57 and the level shifter 55. The Data latch 54 is electrically connected to the level shifter 55, the data register 52, and the shift register 53.

In this embodiment, the storage unit 3 is an EEPROM, for example. In other embodiments, the storage unit 3 can also be other types of non-volatile memory, such as a flash memory, or an EPROM. The storage unit 3 is stored with a plurality of digital gamma data. The digital gamma data are characteristically related to the gamma curve of the predetermined colors respectively. For instance, the predetermined colors can be red (R), green (G), blue (B), white (W), yellow (Y), or cyan (C). That is, the digital gamma data can be characteristically related to RGBW, RGBY or RGBC, achieving better color performance through a multi-color calibration system. Besides, during the manufacturing process, the digital gamma data can be stored in the storage unit 3 in the form of reference tables such that the source drive IC 5 can select the reference table to use therefrom according to environmental parameters such as temperature or the like.

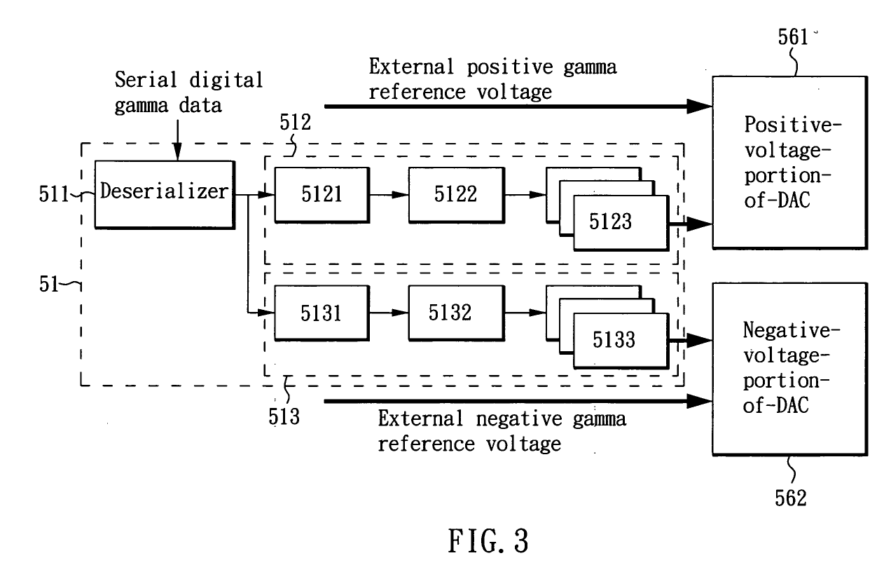

FIG. 3 depicts the functional block diagram of the internal gamma voltage generator, according to the present invention, and reference is also made to FIG. 2 for illustration. The internal gamma voltage generator 51 comprises a deserializer 511, a positive gamma reference voltage generator 512, and a negative gamma reference voltage generator 513. The positive gamma reference voltage generator 512 comprises a first internal DAC 5121, a first sample-and-hold circuit 5122, and a plurality of first unity-gain buffers 5123. The negative gamma reference voltage generator 513 comprises a second internal DAC 5131, a second sample-and-hold circuit 5132, and a plurality of second unity-gain buffer 5133.

The deserializer 511 is electrically connected to the positive gamma reference voltage generator 512 and the negative gamma reference voltage generator 513. Specifically, the deserializer 511 is electrically connected to both the first internal the DAC 5121 of the positive gamma reference voltage generator 512 and the second internal DAC 5131 of the negative gamma reference voltage generator 513. The first internal DAC 5121 is also electrically connected to the first sample-and-hold circuit 5122, and the first sample-and-hold circuit 5122 is electrically connected to the first unity-gain buffers 5123. The second internal DAC 5131 is also electrically connected to the second sample-and-hold circuit 5132, and the second sample-and-hold circuit 5132 is electrically connected to the second unity-gain buffers 5133.

Referring to FIGS. 2 and 3, the internal gamma voltage generator 51 receives the serial digital gamma data supplied by the storage unit 3, and according to the digital gamma data, generates a plurality of sets of internal gamma reference voltages for outputting to the DAC module 56. For instance, if the source driver IC 5 makes use of the RGBW gamma reference voltages, then the storage unit 3 supplies digital gamma data characteristically related to the RGBW colors (i.e. the digital gamma data is characteristically related to the gamma curve of each of the colors respectively) to the internal gamma voltage generator 51 of the source driver IC 5. Then; after the internal gamma voltage generator 51 receives the digital gamma data, the deserializer 511 divides the serial digital gamma data into a first digital data and a second digital data, wherein the first digital data is transmitted to the positive gamma reference voltage generator 512, and the second digital data is transmitted to the negative gamma reference voltage generator 513.

Further referring to FIGS. 2 and 3, the positive gamma reference voltage generator 512 generates a plurality of sets of internal positive gamma reference voltages according to the first digital data for outputting to the DAC module 56. That is, after receiving the first digital data, the first internal DAC 5121 of the positive gamma reference voltage generator 512 converts the first digital data into a positive internal gamma reference voltage, and through the sample-and-hold circuit 5122, the positive internal gamma reference voltage is output to one set of the first unity gain buffers 5123 for voltage stabilization. The stabilized positive internal gamma reference voltage is then output to the positive-voltage-portion-of-DAC 561 of the DAC module 56, as shown in FIG. 3.

Referring to FIG. 3, the sample-and-hold circuit 5122 comprises a plurality of sample-and-hold units, with each of which sampling the positive internal gamma reference voltage characteristically related to one of the colors. For instance, one of the sample-and-hold units can sample a plurality of sets of the positive internal gamma reference voltages characteristically related to the color red (R). That sample-and-hold unit then can transmit the sampled voltages to the corresponding part of the first unity-gain buffers 5123.

Similarly, the negative gamma reference voltage generators 513 generate a plurality of sets of the internal negative gamma reference voltages according to the second digital data for outputting to the DAC module 56. That is, after receiving the second digital data, the second internal DAC 5131 of the negative gamma reference voltage generator 513 converts the second digital data into a negative internal gamma reference voltage, and through the sample-and-hold circuit 5132 the negative internal gamma reference voltage is output to one set of the second unity gain buffers 5133 for voltage stabilization. The stabilized negative internal gamma reference voltage is then output to the negative-voltage-portion-of-DAC 562 of the DAC module 56.

Although the source driver IC 5 makes use of more than one gamma reference voltages characteristically related to the colors, only one transmission line is sufficient for operation since in this embodiment the digital gamma data characteristically related to the colors is already stored in the storage unit 3 and transmitted via the serial transmission line 30, for example. Through such configuration, the wiring area on the PCB and manufacturing costs can therefore be greatly reduced.

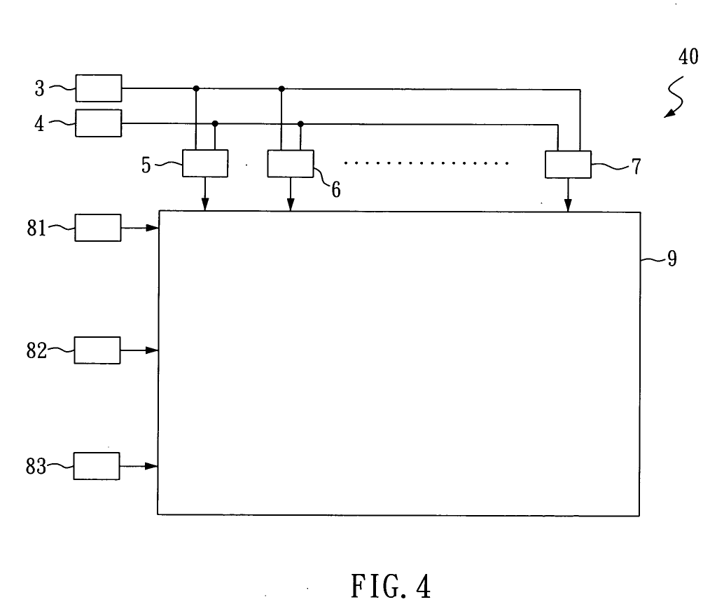

FIG. 4 is a schematic diagram illustrating a preferred embodiment of an LCD module 40, according to the present invention. The LCD module 40 comprises a storage unit 3, an external (second) gamma voltage generator 4, a plurality of source driver ICs 5, 6, and 7, a plurality of gate driver ICs 81, 82, and 83, and a display panel 9. The source driver ICs 5, 6, and 7 and the gate driver ICs 81, 82, and 83 are all electrically connected to the display panel 9. The storage unit 3 is electrically connected to the source driver ICs 5, 6, and 7. The external gamma voltage generator 4 is electrically connected to the source driver ICs 5, 6, and 7. The operation of the source driver ICs 5, 6, and 7 is as previously described.

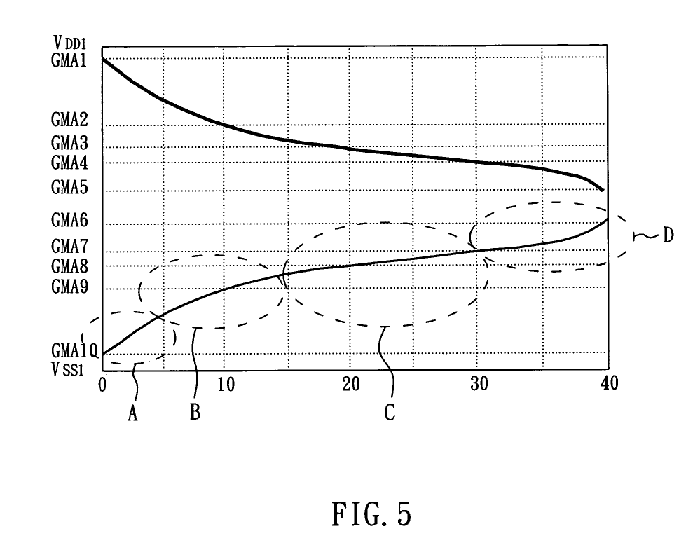

FIG. 5 is a plot illustrating the gamma curve of a source driver IC, according to the present invention, which is divided into four parts, i.e., A, B, C, and D. The parts A, B, and D on the plot experience greater changes (i.e., greater change in gray levels), and the part C experiences less changes (i.e., smaller change in gray levels). Therefore, when the video data received by the source drive IC fall within the predetermined section of the gamma curve (part C of the curve), the DAC module receives the plurality of sets of externally input gamma reference voltages (characteristically related to the gamma curve of one of the colors) supplied by the external gamma voltage generator. The externally input gamma reference voltage comprises a plurality of sets of external positive gamma reference voltages and external negative gamma reference voltages. The DAC module then converts the received video data according to the externally input gamma reference voltages. Alternatively, when the video data received by the source driver IC do not fall within the predetermined section of the gamma curve (i.e., fall within A, B, D parts of the curve), the DAC module converts the received video data according to the internal gamma reference voltages.

Thus, with the hybrid analog/digital gamma voltage generation supplied by the embodiment of the present invention, when the source driver IC displays part of a picture, the internal gamma reference voltage is generated according to the digital gamma data, which are characteristically related to at least one color. Also, the present invention achieves better color performance without the use of the excessive wiring area that increases size and manufacturing costs. Additionally, when certain pictures are displayed, the source driver IC can still employ conventional methods to supply gamma reference voltages, and hence without the use of the excessive internal gamma reference voltages (which are characteristically related to at least a color) but rather merely one set of the external gamma reference voltage characteristically related to certain colors is sufficient to achieve the required color performance, thus reducing power consumption.

Although the present invention has been explained in relation to its preferred embodiments, it is to be understood that many other possible modifications and variations can be made without departing from the spirit and scope of the invention as hereinafter claimed.

What is claimed is:

1. A driving circuit for use in a liquid crystal display (LCD) device, comprising:
a storage unit for storing a plurality of digital gamma data; and
a source driver integrated circuit (IC) electrically connected to the storage unit, wherein the digital gamma data are transmitted from the storage unit to the source driver IC, the source driver IC comprising:
a first gamma voltage generator for generating a plurality of sets of first gamma reference voltages according to the plurality of digital gamma data; and
a digital analog converter module for receiving the first gamma reference voltages supplied by the first gamma voltage generator, and for receiving a plurality of sets of second gamma reference voltages, wherein the first gamma reference voltages are characteristically related to the gamma curve of a plurality of first determined colors, and the second gamma reference voltages are characteristically related to the gamma curve of a second predetermined color, so that the digital analog converter module converts video data according to the first gamma reference voltages or the second gamma reference voltages.

2. The driving circuit of claim 1, wherein the first gamma voltage generator comprises a deserializer, a positive gamma reference voltage generator, and a negative gamma reference voltage generator, wherein the deserializer is connected to the positive gamma reference voltage generator and the negative gamma reference voltage generator.

3. The driving circuit of claim 2, wherein the deserializer receives the serial digital gamma data supplied by the storage unit, for dividing the serial digital gamma data into a first digital data and a second digital data, and for respectively outputting to the positive gamma reference voltage generator and the negative gamma reference voltage generator.

4. The driving circuit of claim 3, wherein the positive gamma reference voltage generator generates a plurality of positive gamma reference voltages according to the first digital data for outputting to the digital analog converter module, and the negative gamma reference voltage generator generates a plurality of negative gamma reference voltages according to the second digital data for outputting to the digital analog converter module

5. The driving circuit of claim 2, wherein the positive gamma reference voltage generator comprises a first digital analog converter, a first sample-and-hold circuit, and a plurality of first unity-gain buffers, wherein the first digital analog converter is electrically connected to the deserializer and the first sample-and-hold circuit, and the first sample-and-hold circuit is electrically connected to the first unity-gain buffers.

6. The driving circuit of claim 5, wherein the first digital analog converter receives a first digital data and converts the same into one of the gamma reference voltages to be transmitted to one of the unity-gain buffers and output to the digital analog converter module.

7. The driving circuit of claim 2, wherein the negative gamma reference voltage generator comprises a second digital analog converter, a second sample-and-hold circuit, and a plurality of second unity-gain buffers, the second digital analog converter respectively is connected to the deserializer and the second sample-and-hold circuit respectively, and the second sample-and-hold circuit is electrically connected to the second unity-gain buffers.

8. The driving circuit of claim 1, wherein the plurality of digital gamma data is stored in the storage unit in the form of reference tables, and the source driver IC determines the reference tables for use therefrom according to an environmental parameter.

9. The driving circuit of claim 1, wherein the first predetermined colors are red, green, blue, or white.

10. The driving circuit of claim 1, wherein the first predetermined colors are red, green, blue, or yellow.

11. The driving circuit of claim 1, wherein the first predetermined colors are red, green, blue, or cyan.

12. A liquid crystal display (LCD) device, comprising:
a display panel;
a storage unit for storing a plurality of digital gamma data; and
at least one source driver integrated circuit (IC) electrically connected to the display panel and the storage unit, wherein the plurality of digital gamma data are transmitted from the storage unit to the at least one source driver IC, the at least one source driver IC comprising:
a first gamma voltage generator for generating a plurality of first gamma reference voltages according to the plurality of digital gamma data; and
a digital analog converter module for receiving the first gamma reference voltages supplied by the first gamma voltage generator, and for receiving a plurality of second gamma reference voltages, wherein the first gamma reference voltages are characteristically related to the gamma curve of a plurality of first determined colors, and the second gamma reference voltages are characteristically related to the gamma curve of a second predetermined color, so that the digital analog converter module converts video data according to the first gamma reference voltages or the second gamma reference voltages.

13. The LCD device of claim 12, wherein the first predetermined colors are red, green, blue, or white.

14. The LCD device of claim 12, wherein the first predetermined colors are red, green, blue, or yellow.

15. The LCD device of claim 12, wherein the first predetermined colors are red, green, blue, or cyan.

16. The LCD device of claim 12, wherein the first gamma voltage generator comprises a deserializer, a positive gamma reference voltage generator, and a negative gamma reference voltage generator, wherein the deserializer is electrically connected to the positive gamma reference voltage generator and the negative gamma reference voltage generator.

17. The LCD device of claim 16, wherein the deserializer receives the serial digital gamma data supplied by the storage unit, for dividing the serial digital gamma data into first digital data and second digital data, and for respectively outputting to the positive gamma reference voltage generator and the negative gamma reference voltage generator.

18. The LCD device of claim 17, wherein the positive gamma reference voltage generator generates a plurality of positive gamma reference voltages according to the first digital data for outputting to the digital analog converter module, and the negative gamma reference voltage generator generates a plurality of negative gamma reference voltages according to the second digital data for outputting to the digital analog converter module

19. The LCD device of claim 16, wherein the positive gamma reference voltage generator comprises a first digital analog converter, a first sample-and-hold circuit, and a plurality of first unity-gain buffers, wherein the first digital analog converter is respectively connected to the deserializer and the first sample-and-hold circuit, and the first sample-and-hold circuit is electrically connected to the first unity-gain buffers.

20. The LCD device of claim 19, wherein the first digital analog converter receives a first digital data and converts the same into one of the gamma reference voltages to be transmitted to one of the unity-gain buffers and output to the digital analog converter module.

21. The LCD device of claim 16, wherein the negative gamma reference voltage generator comprises a second digital analog converter, a second sample-and-hold circuit, and a plurality of second unity-gain buffers, wherein the second digital analog converter is respectively connected to the deserializer and the second sample-and-hold circuit, and the second sample-and-hold circuit electrically is connected to the second unity-gain buffers.
